(19) United States
(12) Patent Application Publication
(10) Pub. No.: US 2002/0051094 A1
(43) Pub. Date: May 2, 2002

(54) Aperture element for video projector and video projector using the same aperture element

(75) Inventor: Kazuya Makita, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC VIEWTECHNOLOGY, LTD.

(21) Appl. No.: 09/982,790

(22) Filed: Oct. 22, 2001

(30) Foreign Application Priority Data
Oct. 26, 2000 (JP) 326279/2000

(51) Int. Cl. H04N 9/31; H04N 5/74

(52) U.S. Cl. 348/744; 348/781

(57) ABSTRACT

A reflecting portion is formed on a periphery of an opening portion 20 of an aperture element for a video projector. The reflecting portion 21 reflects a portion of illumination light illuminating a reflecting type display element, which is other than necessary portion for expanding and projecting an image information by a projecting lens, to an area outside an incident area of the projecting lens such that the light portion is not incident on the projecting lens.

### BACKGROUND OF THE INVENTION

1. Field of the Invention

The present invention relates to an aperture element for a video projector and a video projector using the same aperture element and, in particular, to an aperture element provided in an illuminating optical system, which is positioned between a reflecting type display and a light source of a video projector and includes a projecting lens system, and a video projector using the same aperture element.

2. Description of the Prior Art

In a conventional reflecting type video projector using a reflecting type display such as a reflecting type liquid crystal display panel or a DMD (Digital Micromirror Device, a registered trademark of Texas Instruments, Inc.), etc., an aperture element is often arranged in an illuminating optical system provided between a light source and the reflecting type display.

FIG. 1 schematically shows a construction of a conventional reflecting type video projector. In FIG. 1, the conventional reflecting type video projector includes a light source 1, a reflector 2, a convex lens 3, dichroic mirrors 4B and 4R, convex lenses 5B, 5R and 5R, polarizing beam splitter 6B, 6G and 6R, reflecting type liquid crystal panels 8B, 8G and 8R, a color synthesizing prism 9, a projecting lens 10, a screen 11, a reflecting mirror 12 and identical aperture elements 40B, 40G and 40R.

The aperture element 40B is provided in substantially parallel to the reflecting type liquid crystal panel 8B and the aperture elements 40G and 40R are provided in substantially parallel to the reflecting type liquid crystal panels 8G and 8R, respectively, in a similar manner.

A reference numeral 100B in FIG. 1 depicts an illuminating optical system of blue illuminating light component of white light emitted from the light source 1. This will be referred to as “B system”, hereinafter. Similarly, a reference numeral 100G depicts an illuminating optical system of green illuminating light component of white light emitted from the light source 1 and is referred to as “G system”, hereinafter and a reference numeral 100R depicts an illuminating optical system of red illuminating light component of white light emitted from the light source 1 and is referred to as “R system”, hereinafter.

FIG. 2 is a perspective view of a conventional aperture element 40, which is any one of the identical aperture elements 40B, 40G and 40R. In FIG. 2, the aperture element 40 includes an opening portion 41 for passing only a light component of the illuminating light, which is necessary to project an image onto the screen 11, to illuminate the reflecting type liquid crystal panels 8B, 8G and 8R and a light shield portion 42 for blocking other useless or detrimental light portion of the illumination light to prevent the useless light from illuminating the reflecting type liquid crystal panels 8B, 8G and 8R.

An operation of the conventional reflecting type video projector and a function of the aperture element 40 will be described with FIG. 1 and FIG. 2. In FIG. 1 and FIG. 2, light emitted from the light source 1 is reflected by the reflector 2, which is a parabolic mirror as illumination light.

The illumination light is converted into a substantially parallel light beam by the convex lens 3 and separated to, for example, three primary color (blue, red and green) illumination lights by the dichroic mirrors 4B and 4R. That is, the blue color light of the illumination light beam from the convex lens 3 is selectively reflected by the dichroic mirror 4B and the remaining color lights pass through the dichroic mirror 4B.

The dichroic mirror 4R selectively reflects red color light of the light passed through the dichroic mirror 4B and allows the remaining green color illumination light to pass through. A behavior of the three color illumination lights separated in this manner will be described in the order of the B system, the G system and the B system.

In the B system, the blue color illumination light reflected by the dichroic mirror 4B is reflected by the reflecting mirror 12, passes through the convex lens 5B to the polarizing beam splitter 6B and is emitted to the liquid crystal panel 8B.

The blue color illumination light is directed to the aperture element 40B and only portion thereof, which is necessary to project the image information displayed on the liquid crystal panel 8B onto the screen 11, passes through the opening portion 41 of the aperture element 40B. The remaining useless light portion of the blue color illumination light is blocked by the light shield member 42 of the aperture element 40B, so that it does not illuminate the liquid crystal panel 8B.

The blue light passed through the opening portion 41 of the aperture element 40B is incident substantially vertically onto the liquid crystal panel 8B. The liquid crystal panel 8B modulates the blue illumination light optically and emits an image light (image information). The image light emitted from the liquid crystal panel 8B passes through the opening portion 41 again and is incident on the polarizing beam splitter 6B.

The polarizing beam splitter 6B allows a predetermined polarized light component of the image light to pass therethrough to the color synthesizing prism 9.

In the G system, the green color illumination light passed through the dichroic mirror 4R is incident on the polarizing beam splitter 6G through the convex lens 5G and directed to the liquid crystal panel 8G.

Similarly to the blue color illumination light, only portion of the green illumination color, which is necessary to project the image information displayed on the liquid crystal panel 8G onto the screen 11, passes through the opening portion 41 of the aperture element 40G. The remaining useless light portion of the blue color illumination light is blocked by the light shield member 42 of the aperture element 40G, so that it does not illuminate the liquid crystal panel 8G. Since the operation of the G system after the aperture element is similar to that of the B system, detailed description thereof is omitted.

In the R system, the red color illumination light reflected by the dichroic mirror 4R is incident on the polarizing beam splitter 6R through the convex lens 5R and directed to the liquid crystal panel 8R similarly to the green color illumination light. Since the operation of the R system thereafter is similar to that of the B and G systems, detailed description thereof is omitted.

The blue, green and red color image lights emitted from the respective polarizing beam splitters 6B, 6G and 6R are synthesized by the color synthesizing prism 9. The synthesized image light are expanded and projected onto the screen 11 by the projecting lens 10.

Incidentally, in the reflecting type video projector having no such aperture element as the aperture element 40 provided, a whole portion of the illumination light illuminates the reflecting type display element without shielding any portion thereof. Therefore, temperature of the reflecting type display element tends to increase compared with the reflecting type projector shown in FIG. 1. Further, a portion of the illumination light, which is to be shielded by the aperture element 40 if any, is reflected by the reflecting type display element and incident on the projecting lens 10. This light portion passed the projecting lens 10 may produce an image of stray light, etc., in an unexpected position on the screen 11.

The aperture element 40 is adapted to block a portion of the illumination light, which is a cause of the above-mentioned problem, that is, to shield the useless light portion for the reflecting type display element.

However, even when the aperture element 40 is arranged, there is a problem that a portion of the illumination light is reflected by the light shield portion 42 of the aperture element 40 and incident on the projecting lens 10, with which an image of stray light, etc., in an unexpected position on the screen 11. This phenomenon is illustrated by long dashed-double short dashed lines 200 in FIG. 1.

### SUMMARY OF THE INVENTION

A first object of the present invention is to provide an aperture element for use in a video projector, for preventing an image other than a desired image or a stray light from being projected on the screen and a video projector using the same aperture element.

A second object of the present invention is to provide an aperture element for use in a video projector, which is capable of improving contrast, which is one of optical performances of the video projector, and a video projector using the same aperture element.

An aperture element according to the present invention is provided in an illumination optical system of a video projector, which includes a projecting lens and arranged between a reflecting display element and a light source, and is featured by comprising an opening portion for allowing an illumination light from the light source to pass to the reflecting type display and a reflecting portion in a peripheral portion of the opening portion for reflecting useless portion of the illumination light from the light source to an area outside an incident area of the projecting lens.

In the above mentioned aperture element, the reflecting portion may be formed on the aperture element with a predetermined angle with respect to a plane of the opening portion thereof.

The reflecting portion of the aperture element is provided on a whole peripheral portion of the opening portion.

Alternatively, the reflecting portion of the aperture element may be formed on the side of the periphery of the opening portion in which an incident angle of the illumination light, which is incident on the reflecting type display at an angle other than a right angle, on the plane of the opening portion is acute.

A video projector according to the present is featured by comprising the above-mentioned aperture element.

A performance of the video projector according to the present invention will be described. The reflecting portion of the aperture element reflects a portion of an illumination light incident thereon to an area outside an incident area of the projecting lens such that the portion of the illumination light, which is useless or detrimental to projection of image information displayed on the reflecting type display element, is not incident on the projecting lens. The reflecting portion formed on the periphery of the opening portion of the aperture element at a predetermined angle with respect to the plane of the opening portion reflects the illumination light to an area of the projecting lens outside the incident area thereof such that the useless portion of the illumination light is not incident on the projecting lens. Further, the reflecting portion formed on the whole peripheral portion of the opening portion at the predetermined angle with respect to the plane of the opening portion reflects the illumination light to an area outside the incident area of the projecting lens such that a useless portion of the illumination light is not incident on the projecting lens. Further, the reflecting portion formed at a predetermined angle on the side of the peripheral portion of the opening portion of the aperture element, in which an angle between the incident illumination light incident on the reflecting type display element at other angle than a right angle and the plane of the opening portion is acute, reflects the illumination light to an area outside the incident area of the projecting lens such that the useless portion of the illumination light is not incident on the projecting lens.

### BRIEF DESCRIPTION OF THE DRAWINGS

FIG. 1 schematically shows a construction of a conventional reflecting type video projector;

FIG. 2 is a perspective view of a conventional aperture element shown in FIG. 1;

FIG. 3 schematically shows a construction of a reflecting type video projector according to an embodiment of the present invention;

FIG. 4A is a perspective view of an aperture element 7 shown in FIG. 3;

FIG. 4B is a front view of the aperture element shown in FIG. 4A;

FIG. 4C is a side view of the aperture element shown in FIG. 4A;

FIG. 4D is a rear view of the aperture element shown in FIG. 4A;

FIG. 4E is a cross section taken along a line A-A in FIG. 4D;

FIG. 5 schematically shows a construction of a reflecting type video projector according to a second embodiment of the present invention;

FIG. 6A is a perspective view of an aperture element 17 shown in FIG. 5;

FIG. 6B is a front view of the aperture element shown in FIG. 6A;

FIG. 6C is a side view of the aperture element shown in FIG. 6A;

FIG. 6D is a rear view of the aperture element shown in FIG. 6A; and

FIG. 6E is a cross section taken along a line B-B in FIG. 6D.

### DETAILED DESCRIPTION OF THE PREFERRED EMBODIMENTS

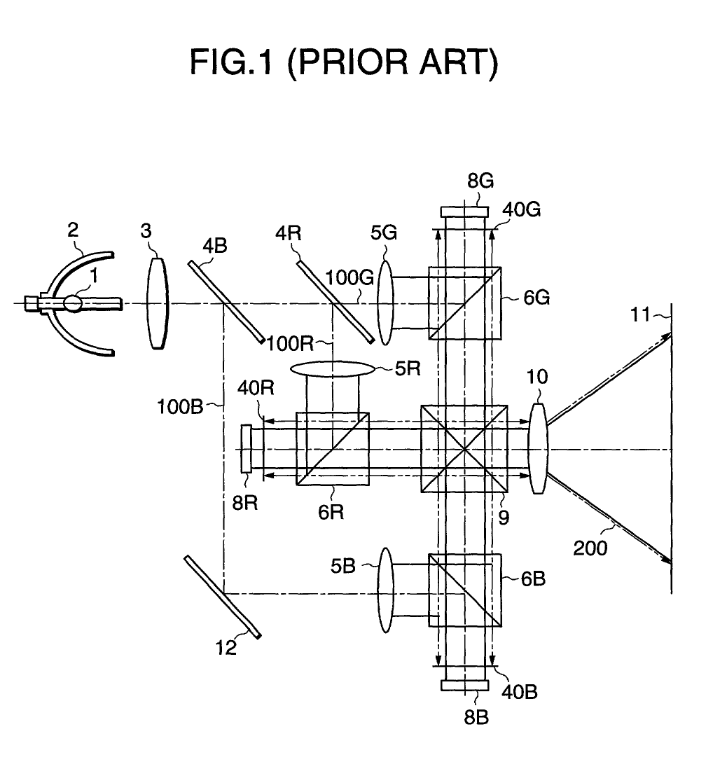

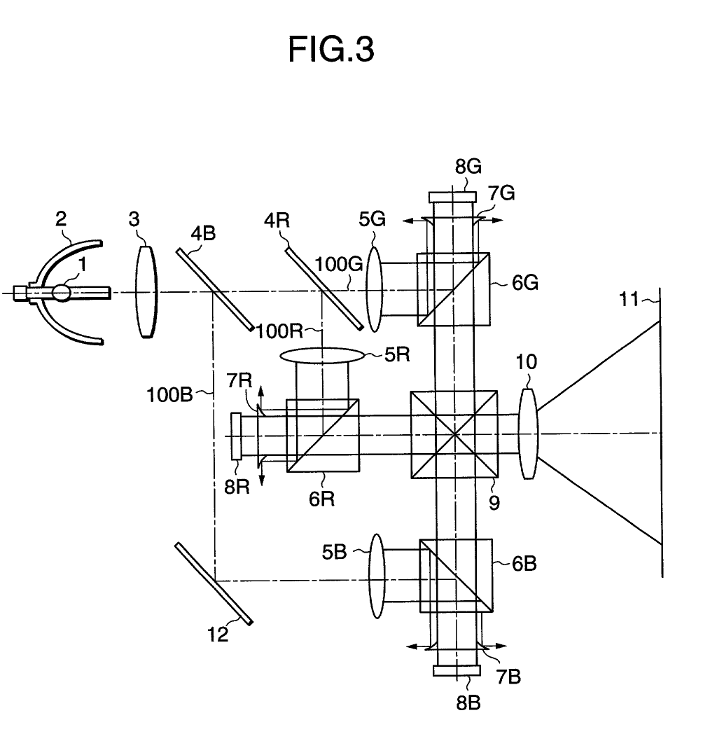

The present invention will be described with reference to the drawings. FIG. 3 schematically shows a construction of a reflecting type video projector according to an embodiment of the present invention, in which same constructive components of the reflecting type video projector as those shown in FIG. 1 are depicted by same reference numerals, respectively.

In FIG. 3, the reflecting type video projector according to this embodiment includes a light source 1, a reflector 2, a convex lens 3, dichroic mirrors 4B and 4R, convex lenses 5B, 5G and 5R, polarizing beam splitters 6B, 6G and 6R, identical aperture elements 7B, 7G and 7R, reflecting type liquid crystal panels 8B and 8R, a color synthesizing prism 9, a projecting lens 10, a screen 11 and a reflection mirror 12.

The aperture element 7B is provided substantially in parallel to the reflecting type liquid crystal panel 8B and the aperture elements 7G and 7R are also provided similarly with respect to the reflecting type liquid crystal panels 8G and 8R, respectively.

That is, the reflecting type video projector of the present invention differs from the conventional projector shown in FIG. 1 in only the aperture elements 7B, 7G and 7R and, therefore, description of the operation of other constructive components of the present reflecting type projector than the aperture elements will be omitted for avoidance of duplication.

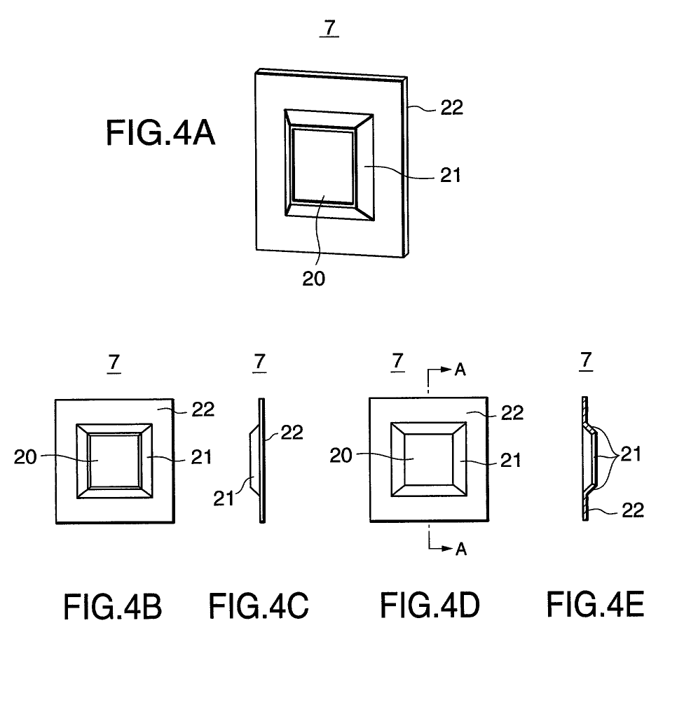

FIG. 4A to FIG. 4E show a construction of the aperture element 7 shown in FIG. 3, in which FIG. 4A is a perspective view of an aperture element 7, FIG. 4B is a front view of the aperture element shown in FIG. 4A, FIG. 4C is a side view of the aperture element shown in FIG. 4A, FIG. 4D is a rear view of the aperture element shown in FIG. 4A and FIG. 4E is a cross section taken along a line A-A in FIG. 4D. In FIG. 4A to FIG. 4E, an aperture element 7 is any of the aperture elements 7B, 7G and 7R and has an opening portion 20, a reflecting portion 21 and a light shield portion 22.

The opening portion 20 allows only portion of an illumination light from any one of the polarizing beam splitters 6B, 6G and 6R, which portion is necessary to project an image onto the screen 11, to pass through and to illuminate one of the reflecting type liquid crystal panels 8B, 8G and 8R.

The reflecting portion 21 is provided in a periphery of the opening portion 20 at a predetermined angle with respect to a plane of the opening portion 20 and functions to prevent a useless or detrimental portion of the illumination light from being incident on the related reflecting type polarizing beam splitter and to reflect the useless light portion to an area outside an incident area of the projecting lens 10 such that it is not incident on the projecting lens 10.

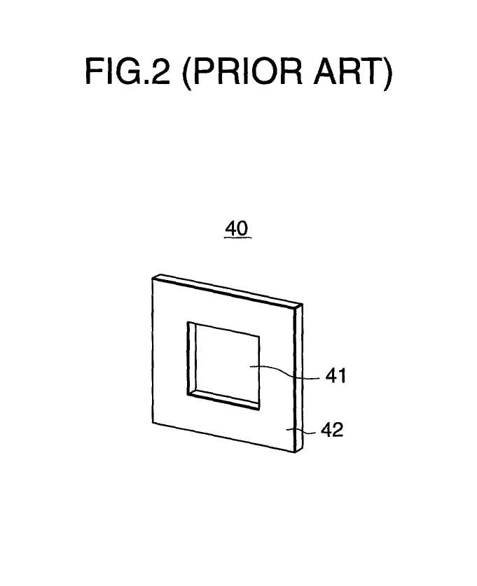

The light shield portion 22 surrounds the opening portion 20 such that the useless light portion of the illumination light does not illuminate the related reflecting type liquid crystal panel. The useless light portion reflected by the light shield portion 22 is never incident on the projecting lens 10, because, in the present invention, the reflecting portion 21 is provided in a portion of the aperture element 20 corresponding to an area of the conventional aperture element 40 shown in FIG. 2, on which the light reflected by the light shield portion 42 of the conventional aperture element 40 is to be incident.

In the present invention, the illumination light illuminates the front surface of the aperture element 7 including the slanted reflecting portion 21 protruding from the front plane thereof at the predetermined angle with respect to the front plane as shown in FIG. 4B, and passes through the opening portion 20.

In FIG. 3 and FIG. 4A to FIG. 4E, only a portion of the blue illumination light from the polarizing beam splitter 6B in the B system 100B, which is necessary to project the image information displayed on the liquid crystal panel 8B onto the screen 11, passes through the opening portion 20 of the aperture element 7B. The reflecting portion 21 and the light shield portion 22 block other illumination light portion than the necessary light portion, so that the useless light portion thereof never illuminates the liquid crystal panel 8B.

Since the reflecting portion 21 is provided at the predetermined angle with which the useless blue illumination light is reflected toward the area outside the incident area of the projecting lens 10, the useless light reflected thereby is never incident on the projecting lens 10.

The necessary blue illumination light passed through the opening portion 20 of the aperture element 7B is incident on the liquid crystal panel 8B at substantially a right angle. The liquid crystal panel 8B optically modulates the blue illumination light and emits an image light. The image light emitted from the liquid crystal panel 8B passes through the opening portion 20 of the aperture element 7B again and is incident on the polarizing beam splitter 6B.

The polarizing beam splitter 6B passes a predetermined polarized component of the image light toward the color synthesizing prism 9. The function of the G system as well as the R system is similar to that of the B system.

The blue, green and red color images from the respective polarizing beam splitters 6B, 6G and 6R in this manner are synthesized by the color-synthesizing prism 9. A resultant color image light is expanded by the projecting lens 10 and projected onto the screen 11.

As described, there is the slanted reflecting portion 21 provided to surround the opening portion 20 of the aperture element 7. Therefore, the portions of the illumination light, which are prevented from being incident on the reflecting type liquid crystals 8B, 8G and 8R by the reflecting portions 21 of the aperture elements 7B, 7G and 7R, are reflected in direction to areas outside the projecting lens 10.

In the described embodiment, the aperture element 7 is preferably formed of a heat durable, translucent material such as, for example, copper, having high thermal conductivity. When a copper plate is used to form the aperture element 7, it is possible to easily form the reflecting portion 21 by a punching press. Further, in order to prevent light incident on a surface of the reflecting portion 21, that is, the surface thereof illuminated with the illumination light, from scattering due to increase of an amount of illumination light, the surface of the reflecting portion 21 may be mirror-polished. Further, in order to facilitate absorption of illumination light, it is preferable that a surface of the light shield portion 22, which is illuminated with the illumination light, is blackened by painting or plating.

The predetermined angle of the reflecting portion 21 of the aperture element 7 with respect to the plane thereof is preferably in a range from 25 degrees to 65 degrees although the most preferable angle is 45 degrees. However, the predetermined angle depends upon with the sizes of the aperture element 7 and the polarizing beam splitter 6 and the positional relation therebetween. The object of the present invention can be achieved with using the predetermined angle being in a range from 5 degrees to 85 degrees.

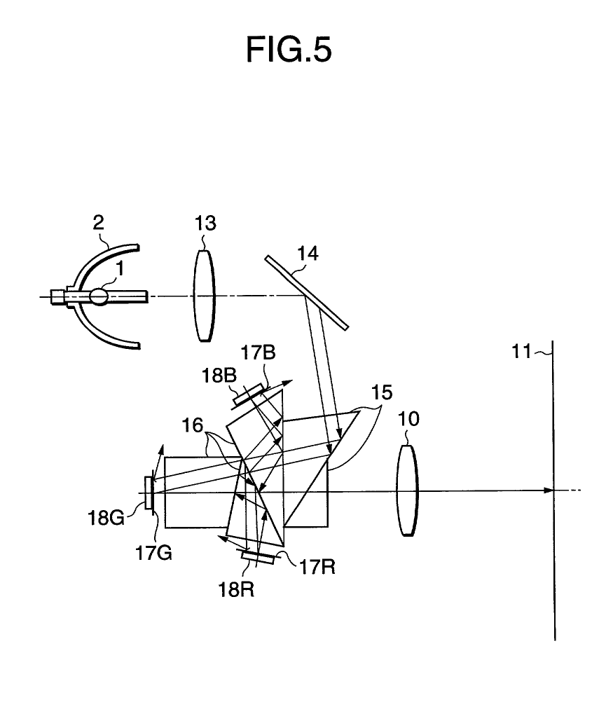

A reflecting type projector according to a second embodiment of the present invention will be described with reference FIG. 5. In FIG. 5, same constructive components as those shown in FIG. 1 and FIG. 3 are depicted by same reference numerals, respectively, without detailed description thereof.

In FIG. 5, the reflecting type video projector includes a light source 1, a reflector 2, a projecting lens 10, a screen 11, a relay lens 13, a reflecting mirror 14, a reflecting prism 15 composed of 2 prisms, a color prism 16 composed of 3 parts, identical aperture elements 17B, 17G and 17R and DMD's 18B, 18G and 18R.

The DMD used in this embodiment is one of the known reflecting type display elements and is constructed with a plurality of micro mirrors supported by respective flexible support members and arranged in a matrix and control electrodes each provided in the vicinity of each micro mirror. By supplying video signals corresponding to respective pixels to the control electrodes, respectively, reflecting faces of the micro mirrors are selectively deflected by electrostatic attraction forces generated by the video signals to reflect light reflected by specific ones of the micro mirrors to a color prism.

The aperture element 17B is provided substantially in parallel to the DMD 18B. Similarly, the aperture elements 17G and 17R are provided substantially in parallel to the DMD's 18G and 18R, respectively.

The reflecting type video projector according to this embodiment is featured by that illumination light is incident on the DMD's 18B, 18G and 18R at an angle other than a right angle, unlike the reflecting type video projector shown in FIG. 3.

The light source 1 has the reflector 2 having a parabolic mirror and light emitted from the light source 1 is reflected by the reflector 2 as the illumination light. The illumination light passes through the relay lens 13 and reflected by the reflecting mirror 14. The reflected illumination light is separated to a blue, red and green illumination lights by the reflecting prism 15.

Incidentally, the relay lens 13 is to efficiently collect illumination light to the DMD's 18B, 18G and 18R and the reflecting mirror 14 is arranged at a predetermined angle with respect to an optical axis of the illumination light such that the illumination light is incident on the reflecting prism 15 substantially a right angle. Further, the reflecting prism 15 and the color prism 16 function to guide the incident illumination light to the DMD's 18B, 18G and 18R at an angle other than a right angle.

The blue, green and red illumination lights separated by the color prism 16 are directed to the corresponding DMD 18B, 18G and 18R, respectively. That is, the blue illumination light, the green illumination light and the red illumination light are incident on the DMD 18B, the DMD 18G and the DMD 18R through the aperture elements 17B, 17G and 17R, respectively, at angles other than a right angle.

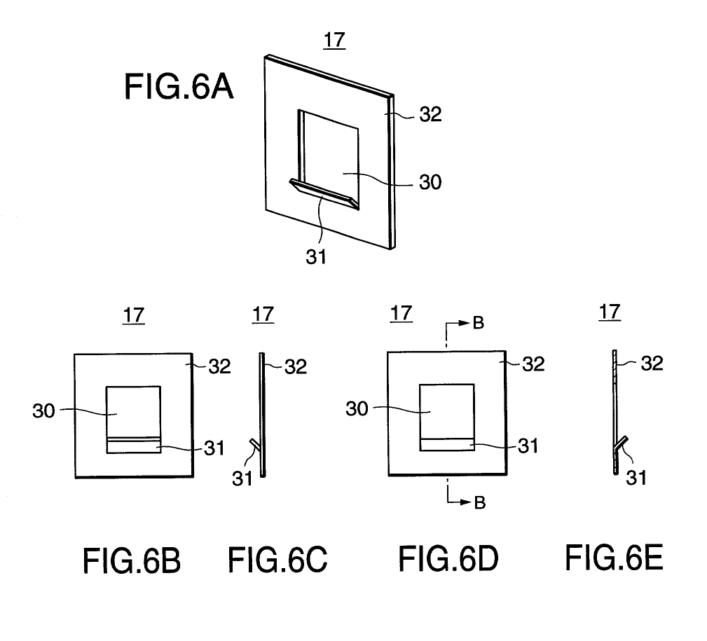

FIG. 6A to FIG. 6E show a construction of the aperture element 17, in which FIG. 6A is a perspective view of an aperture element 17 shown in FIG. 5, FIG. 6B is a front view of the aperture element shown in FIG. 6A, FIG. 6C is a side view of the aperture element shown in FIG. 6A, FIG. 6D is a rear view of the aperture element shown in FIG. 6A and FIG. 6E is a cross section taken along a line B-B in FIG. 6D. In FIG. 6A to FIG. 6E, the aperture element 17, which is used as each of the aperture elements 17B, 17G and 17R, includes an opening portion 30, a reflecting portion 31 and a light shield portion 32.

The opening portion 30 allows only portion of an illumination light emitted from the color prism 16, which is necessary for an image to be projected onto the screen 11, to pass to the DMD's 18B, 18G and 18R.

The reflecting portion 31 is provided in a peripheral portion of the opening portion 30, in which the incident illumination light makes an acute angle with respect to a plane of the opening portion 30, at a predetermined angle with respect to the plane of the opening portion 30. The reflecting portion 31 shields the useless portion of the illumination light such that the useless illumination light is not incident on the DMD's 18B, 18G and 18R and reflects the useless illumination light to an area outside an incident area of the projecting lens 10 such that it is not incident on the projecting lens 10.

The light shield portion 32 surrounds the opening portion 30 and blocks the useless portion of the illumination light such that the useless light portion of the illumination light does not illuminate the DMD's 18B, 18G and 18R. The useless light portion reflected by the light shield portion 32 is never incident on the projecting lens 10. This is because the reflecting portion 31 is provided in a portion of the aperture element 17, on which the useless light reflected by the light shield portion 32 is possibly incident.

The illumination light illuminates the front surface of the aperture element 17 shown in FIG. 6B, from which the reflecting portion 31 protrudes at the predetermined angle with respect thereto, and the necessary portion thereof passes through the opening portion 30.

In FIG. 5 and FIG. 6A to FIG. 6E, since behaviors of the blue, green and red illumination lights emitted from the color prism 16 are similar, the behavior of only the blue illumination light will be described.

The aperture element 17B allows only portion of the blue illumination light, which is necessary to project an image, to pass through the opening portion 30 thereof. The other, useless blue illumination light is blocked by the reflecting portion 31 and the light shield portion 32 and, therefore, the DMD 18B is not illuminated by the useless blue light.

Since the reflecting portion 31 is provided in a peripheral portion of the opening portion 30, in which the incident illumination light makes an acute angle with respect to a plane of the opening portion 30, at a predetermined angle with respect to the plane of the opening portion 30, and, in FIG. 5, it is provided on the upper side of the opening portion 30, the useless light incident on the reflecting portion 31 is reflected to the area outside the incident area of the projecting lens 10.

The DMD 18B reflects the blue image light passed through the opening portion 30 toward the projecting lens 10 by controlling attitudes of the micro mirrors. The blue image light from the DMD 18B passes through the opening portion 30 again and is incident on the color prism 16.

In this manner, the blue, green and red color image lights are synthesized by the color prism 16. The synthesized image light passes through the reflecting prism 15 and is expanded by the projecting lens 10 and projected onto the screen 11.

Also in this embodiment, the aperture element 17 is preferably formed of a heat durable translucent material such as, for example, copper, having high thermal conductivity for the same reason as in the first embodiment. When a copper plate is used to form the aperture element 17, it is possible to easily form the reflecting portion by a punching press. Further, in order to prevent light incident on a surface of the reflecting portion 31, that is, the surface thereof illuminated with the illumination light, from scattering due to increase of an amount of illumination light, the surface of the reflecting portion 31 may be mirror-polished. In such case, it is possible to reliably direct the reflected light such that it is not incident on the projecting lens 10. Further, in order to facilitate absorption of illumination light by the light shield portion 32, it is preferable that a surface of the light shield portion 32, which is illuminated with the illumination light, is blackened by painting or plating. When a copper plate is used for the aperture element, it is preferable to form the reflecting portion by the punching press, etc., to polish it and, then, to blacken the light shield portion by painting it with black paint in order to prevent unnecessary reflection of light.

Although, the predetermined angle of the reflecting portion of the aperture element with respect to the plane thereof is most preferably in a range from 60 degrees to 65 degrees, the range may be from 50 degrees to 75 degrees. However, the predetermined angle depends upon with the sizes of the aperture element 17 and the polarizing beam splitter 16 and the positional relation therebetween. The object of the present invention can be achieved with the predetermined angle being in a range from 40 degrees to 85 degrees.

As described hereinbefore, the advantage of the present invention is that it is possible to prevent generation of unexpected image or stray light on the screen due to reflection of light by the aperture element to thereby improve the contrast of projected image, which is one of the optical characteristics of the projector. This is because the aperture element is provided with the reflecting portion on the periphery of the opening portion thereof such that illumination light reflected by the reflecting portion is not incident on the projecting lens.

In the embodiments shown in FIG. 4A to FIG. 4E and FIG. 6A to FIG. 6E, since the image projected onto the screen 11 is usually square, the opening portions 20 and 30 are square, respectively. However, the configuration of the opening portion may be circular or polygonal, provided that such configuration does not produce any adverse influence on the image projected on the screen.

The construction of the video projector is not limited to those shown in FIG. 3 and FIG. 5. It may be easy for those skilled in the art to modify these embodiments in various manners. What is claimed is:

1. An aperture element for use in a video projector comprising:
a reflecting type display element for reflecting light from a light source as a light beam containing a predetermined image information;
an illuminating optical system including a projecting lens for projecting the light beam containing the image information in a predetermined direction; and
an aperture element provided between said light source and said reflecting type display element, said aperture element including an opening portion for allowing the light from said light source to pass through to said reflecting type display element, and a reflecting portion provided on a periphery of said opening portion to reflect a useless portion of the light from said light source to an area outside an incident area of said projecting lens.

2. An aperture element as claimed in claim 1, wherein said reflecting portion of said aperture element is formed on said periphery of said opening portion at a predetermined angle with respect to a plane of said opening portion.

3. An aperture element as claimed in claim 1, wherein said reflecting portion of said aperture element is provided on a whole periphery of said opening portion.

4. An aperture element as claimed in claim 1, wherein the illumination light is incident on said reflecting type display element at an angle other than right angle and said reflecting portion is provided on a portion of said periphery of said opening portion on the side in which an angle between the incident illumination light and said plane of said opening portion is acute.

5. An aperture element as claimed in claim 1, wherein said reflecting portion of said aperture element is mirror-polished.

6. An aperture element as claimed in claim 1, wherein said aperture element further includes a light shield portion surrounding said opening portion and said light shield portion is blackened.

7. A video projector comprising:
a reflecting type display element for reflecting light from a light source as a light beam containing a predetermined image information;
an illuminating optical system including a projecting lens for projecting the light beam containing the image information in a predetermined direction; and
an aperture element provided between said light source and said reflecting type display element, said aperture element including an opening portion for allowing the light from said light source to pass through to said reflecting type display element and a reflecting portion provided on a periphery of said opening portion to reflect a useless portion of the light from said light source to an area outside an incident area of said projecting lens.

8. A video projector as claimed in claim 7, wherein three sets of said reflecting type display elements and said illumination optical systems corresponding to three primary colors and said aperture element is provided for each set of said reflecting type display element and said illumination optical system.
